(19) United States
(12) Patent Application Publication
(10) Pub. No.: US 2024/0350352 A1
(43) Pub. Date: Oct. 24, 2024

(54) MASSAGE COMB HEAD AND ELECTRICAL MASSAGE COMB

(71) Applicant: WEIXI (SHENZHEN) INTELLIGENT TECHNOLOGY CO., LTD, SHENZHEN (CN)

(72) Inventor: WENBIN LI, SHENZHEN (CN)

(21) Appl. No.: 18/333,565

(22) Filed: Jun. 13, 2023

(30) Foreign Application Priority Data
Apr. 21, 2023 (CN) 202320973131.2

(51) Int. Cl. A61H 11/00; A61H 9/00

(52) U.S. Cl. CPC A61H 11/00; A61H 9/0071; A61H 2201/1409; A61H 2201/169; A61H 2205/021

(57) ABSTRACT

The present application discloses a massage comb head and an electrical massage comb. The massage comb head includes a comb housing, an air guide part and a comb teeth part. The comb housing is provided with an air outlet. The air guide part is installed in the comb housing, and the air guide part is provided with an air outlet end provided towards the air outlet. The comb teeth part includes a soft support, and the soft support is arranged at the air outlet. The soft support is configured to deform towards the air outlet end and stop at the air outlet end or recover its deformation in a direction far away from the air outlet end. The pressure of the comb teeth on the head will be buffered, and the scalp will not be excessively stimulated, so as to ensure the appropriate massage intensity.

### TECHNICAL FIELD

The present application relates to the technical field of dressing equipment, and in particular relates to a massage comb head and an electrical massage comb.

### BACKGROUND

Currently, people have more demands and higher requirements for hair styling. Hair care and hair nourishing have gradually become an indispensable part of our daily life. In related technologies, some combs have emerged that can massage the scalp and enable styling.

However, the comb teeth of these combs exert high pressure on the scalp when massaging the scalp. As a result, the head will feel uncomfortable, and a massage effect is poor.

### SUMMARY

An embodiment of the present application provides a massage comb head and an electrical massage comb, aiming at solving the problem that existing combs for styling have a poor massage effect.

In the first aspect, the present application provides a massage comb head, including a comb housing, an air guide part and a comb teeth part. The comb housing is provided with an air outlet; the air guide part is installed in the comb housing, and the air guide part is provided with an air outlet end provided towards the air outlet; and the comb teeth part includes a soft support, and the soft support is arranged at the air outlet, where the soft support is configured to deform towards the air outlet end and stop at the air outlet end or recover its deformation in a direction far away from the air outlet end.

In the massage comb head provided by the present application, the soft support bulges in a direction far away from the air outlet end, and a gap is formed between the soft support and the air outlet end for forming the deformation of the soft support.

In the massage comb head provided by the present application, the soft support is silica gel, and the softness of the silica gel is 30-80 degrees.

In the massage comb head provided by the present application, the air guide part includes a plurality of air baffles arranged at intervals, the end surface of the air baffle towards the air outlet is the air outlet end, and a plurality of the air outlet ends collectively stop the soft support.

In the massage comb head provided by the present application, the plurality of air baffles are arranged at intervals along a longitudinal direction, and air outlet ducts are formed between the adjacent two air baffles; and the soft support is provided with a plurality of air outlet holes arranged at intervals in a longitudinal and lateral direction, where each air outlet hole in the longitudinal direction respectively corresponds to an outlet of each air outlet duct; and the plurality of air outlet holes in the lateral direction all correspond to the outlets of the same air outlet ducts.

In the massage comb head provided by the present application, the comb teeth part further includes comb teeth, the soft support includes an inner side towards the inside of the comb housing and an outer side facing away from the inner side, and the soft support is provided with via holes that run through the inner side and outer side, where the comb teeth pass through the via holes, and the comb teeth are provided with a first end part connected to the inner side and a second end part connected to the outer side.

In the massage comb head provided by the present application, the massage comb head further includes a ring mounting part, the outside of the ring mounting part is arranged around the air outlet, and the inside of the ring mounting part surrounds the soft support.

In the massage comb head provided by the present application, the ring mounting part includes an outer ring connecting part and an inner ring connecting part, the outer ring connecting part and the inner ring connecting part are installed in an involution manner, and the outer ring connecting part and/or the inner ring connecting part are fixed to the comb housing; and the edge of the soft support protrudes outward and is provided with a connecting portion, and the connecting portion is clamped between the outer ring connecting part and the inner ring connecting part.

In the massage comb head provided by the present application, the connecting portion is provided with a through hole, one side of the outer ring connecting part towards the inside of the comb housing is provided with a clip, the inner ring connecting part is provided with a slot, and the clip is connected to the slot through the through hole in a buckling manner.

In the second aspect, the present application provides an electrical massage comb, including a host for providing airflow and the massage comb head as described above, and the massage comb head is installed on the host.

The present application provides the massage comb head and the electrical massage comb, the massage comb head includes the comb housing, the air guide part and the comb teeth part. The comb housing is provided with the air outlet, the air guide part is installed in the comb housing, the air guide part is provided with the air outlet end, the air outlet end is provided towards the air outlet, the comb teeth part is provided with the soft support, the soft support is arranged at the air outlet, and the soft support has strong deformability. When a user massages the scalp, the pressure is exerted to the comb teeth part, the soft support will be deformed and pressed to the air outlet end of the air guide part, and the air outlet end will support the soft support. The pressure exerted to the comb teeth part is released, and the soft support will rebound to recover its deformation, so that the pressure of the comb teeth on the head will be buffered, and the scalp will not be excessively stimulated, so as to ensure the appropriate massage intensity and enhance the massage effect.

### BRIEF DESCRIPTION OF THE DRAWINGS

In order to explain the technical solutions of embodiments of the present application more distinctly, a brief introduction will be given to the drawings required in the description of embodiments. Obviously, the drawings in the following description are some embodiments of the present application. For those of ordinary skill in the art, other drawings can be obtained according to these drawings without contributing any inventive labor.

FIG. 1 is a schematic exploded view of a massage comb head in an embodiment of the present application;

FIG. 2 is a schematic sectional view of the massage comb head in an embodiment of the present application;

FIG. 3 is a schematic diagram of a comb housing of the massage comb head in an embodiment of the present application;

FIG. 4 is another schematic diagram of the comb housing of the massage comb head in an embodiment of the present application;

FIG. 5 is a schematic diagram of an air guide part of the massage comb head in an embodiment of the present application;

FIG. 6 is a schematic diagram of comb teeth of the massage comb head in an embodiment of the present application;

FIG. 7 is a schematic sectional view of the comb teeth and a soft support of the massage comb head in an embodiment of the present application;

FIG. 8 is an enlarged view of Part A of FIG. 7;

FIG. 9 is a schematic exploded view of a ring mounting part and a comb teeth part of the massage comb head in an embodiment of the present application;

FIG. 10 is a schematic assembly diagram of the ring mounting part and the comb teeth part of the massage comb head in an embodiment of the present application; and

FIG. 11 is a schematic diagram of an electrical massage comb in an embodiment of the present application.

### REFERENCE NUMERALS

10, comb housing; 11, air inlet housing; 111, air inlet; 12, air outlet housing; 121, air outlet; 122, fixed leg; 123, groove block; 20, comb teeth part; 21, soft support; 211, air outlet hole; 212, connecting portion; 213, through hole; 22, comb teeth; 221, first end part; 222, second end part; 223, bead; 30, air guide part; 31, air baffle; 311, air outlet duct; 312, air outlet end; 32, skeleton; 321, mounting hole; 322, lap joint; 40, ring connecting part; 41, outer ring connecting part; 411, clip; 42, inner ring connecting part; 421, slot; and 50, host.

### DETAILED DESCRIPTION

The technical solutions in embodiments of the present application will be described distinctly and completely below in combination with the drawings in embodiments of the present application. Obviously, the described embodiments are some rather than all of the embodiments. Based on embodiments of the present application, all other embodiments obtained by those of ordinary skill in the art without contributing inventive labor shall fall within the scope of protection of the present application.

The direction terms mentioned in the present application, such as “up”, “down”, “front”, “rear”, “left”, “right”, “inside”, “outside” and “side”, etc., are only the directions used for referring to the drawings. Therefore, direction terms are used for explaining and understanding the present application, rather than limiting the present application. In addition, in the drawings, structures with similar or identical structures are represented by the same reference numerals.

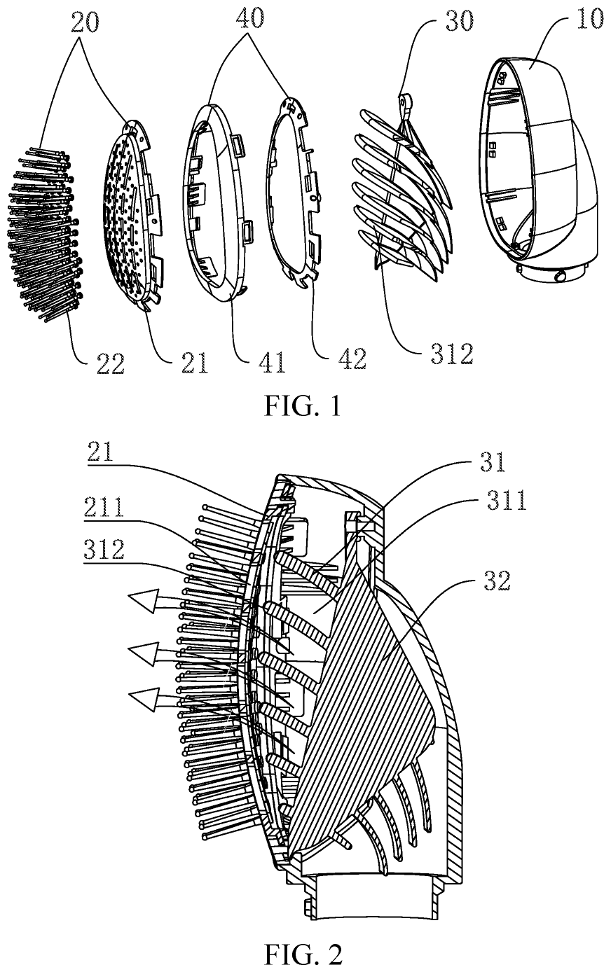

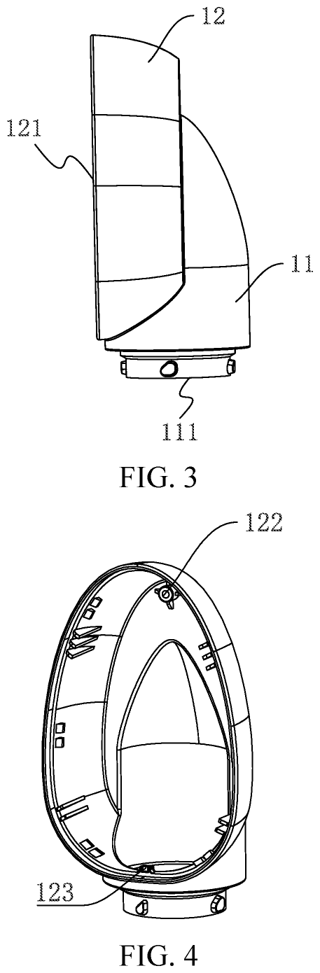

Referring to FIG. 1 and FIG. 2, an embodiment of the present application provides a massage comb head, including a comb housing 10, an air guide part 30 and a comb teeth part 20. The comb housing 10 is provided with an air outlet 121. The air guide part 30 is installed in the comb housing 10, and the air guide part 30 is provided with an air outlet end 312 provided towards the air outlet 121. The comb teeth part 20 includes a soft support 21, and the soft support 21 is arranged at the air outlet 121. The soft support 21 is configured to deform towards the air outlet end 312 and stop at the air outlet end 312 or recover its deformation in a direction far away from the air outlet end 312.

Through the implementation of this embodiment, the soft support 21 has strong deformability. When a user massages the scalp, the pressure is exerted to the comb teeth part 20, and the soft support 21 will be deformed and pressed to the air outlet end 312 of the air guide part 30. The air outlet end 312 will support the soft support 21. The pressure exerted to the comb teeth part 20 is released, and the soft support 21 will rebound to recover its deformation, so that the pressure of the comb teeth 22 on the head will be buffered, and the scalp will not be excessively stimulated, so as to ensure the appropriate massage intensity and enhance the massage effect.

Referring to FIG. 2, in an embodiment, the soft support 21 bulges in a direction far away from the air outlet end 312, and a gap is formed between the soft support 21 and the air outlet end 312 for forming the deformation of the soft support 21. Specifically, the soft support 21 is a layer of drumhead covering the air outlet 121, which has a relatively bulging shape, that is, the surface of the soft support 21 is an arc-shaped surface in its natural state. The bulging direction of the soft support 21 is far away from the air outlet end 312, so there will be a certain gap between the soft support 21 and the air outlet end 312. This gap can provide a deformation space for the deformation of the soft support 21, so that the soft support 21 can be deformed more fully, and the deformability of the soft support 21 can be increased, so the comb teeth part 20 can bear greater buffering and further enhance the comfort of massage.

The soft support 21 is made of soft materials, such as silica gel, rubber and plastic, etc. Any kind of material can be used, as long as it has a certain softness and can generate sufficient deformation, which is not limited here. In the specific implementation, the soft support 21 is silica gel, and the softness of the silica gel is 30-80 degrees. Specifically, the soft support 21 of this embodiment uses silica gel, the silica gel has good plasticity and strong elastic deformability. However, the deformability of silica gel cannot be too strong. If it is too strong, the soft support 21 will be too soft and the massage intensity will be small. The deformability of silica gel cannot be too weak. If it is too weak, the soft support 21 will be too hard, and the massage intensity will be too strong, which will cause discomfort. Therefore, the soft support 21 of this embodiment chooses an appropriate softness range to ensure the appropriate massage intensity. When designing the soft support 21 of this embodiment, the inventor measured an appropriate softness range of 30-80 degrees through experiments. The softness of this embodiment is specifically 40 degrees, and the 40 degree soft support 21 can be easily pressed toward the air outlet end 312 to form a support, with moderate massage intensity of the scalp. Of course, it can be understood that it can also be other softness within the above range.

Referring to FIG. 3 and FIG. 4, in this embodiment, the comb housing 10 includes an air inlet housing 11 and an air outlet housing 12, and the air inlet housing 11 and the air outlet housing 12 are provided with chambers. The air inlet housing 11 is in a hollow cylinder shape as a whole. The air inlet 111 is arranged at the bottom of the air inlet housing 11. The top of the air inlet housing 11 is closed. The side of the air inlet housing 11 is connected to one side of the air outlet housing 12. The top of the air inlet housing 11 is bent towards one side of the air outlet housing 12 and is connected to one side of the air outlet housing 12 in an arc shape. The air outlet housing 12 is in an elliptical disk shape as a whole, one side of the air outlet housing 12 is connected to one side of the air inlet housing 11, and the other side of the air outlet housing 12 is opened to form an air outlet 121. The chamber in the air inlet housing 11 is connected to the chamber in the air outlet housing 12. The central axis of the air inlet 111 and the air outlet 121 are perpendicular to each other, and the airflow enters from the air inlet 111 and is discharged from the air outlet 121 through two chambers. The airflow is guided to the chamber of the air outlet housing 12 by the curved inner wall surface of the air inlet housing 11 in the chamber of the air inlet housing 11. In addition, the bottom of the air inlet housing 11 is further provided with a mounting joint around the air inlet 111. The mounting joint is provided with a plurality of button placements. The plurality of button placements are connected to the host 50 by the mounting joint. The host 50 is used for injecting airflow into the air inlet 111.

Referring to FIG. 5, the air guide part 30 includes a plurality of air baffles 31 arranged at intervals, the plurality of air baffles 31 are connected in series through a skeleton 32, and the skeleton 32 is fixed in the comb housing 10. The air baffles 31 are in a curved shape as a whole. The air baffles 31 are bent and extended from the air inlet 111 towards the air outlet 121. The skeleton 32 runs through and connects the plurality of air baffles 31 longitudinally in the middle. Air outlet ducts 311 are formed between adjacent air baffles 31. The skeleton 32 is in a triangular shape as a whole. The skeleton 32 has a certain extension length on the path of the air inlet 111 towards the air outlet 121. Each air outlet duct 311 is separated by a skeleton 32 and forms two sub-air outlet ducts 311 on the left and right, and the airflow flows from each sub-air outlet duct 311 on the left and right to avoid mutual interference and enhance the air outlet effect. The top of the skeleton 32 is provided with a mounting hole 321. The inner side wall of the comb housing 10 is provided with a fixed leg 122. The mounting hole 321 is fixed with the fixed leg 122. The bottom of the skeleton 32 is provided with a lap joint 322. The inner side wall of the comb housing 10 is provided with a groove block 123. The lap joint 322 is overlapped with the groove block 123.

Referring to FIG. 2, in this embodiment, the air guide part 30 includes the plurality of air baffles 31 arranged at intervals. The end surface of the air baffle 31 towards the air outlet 121 is the air outlet end 312. A plurality of the air outlet ends 312 collectively stop the soft support 21. Specifically, the end surface of the air baffle 31 extending to the air outlet 121 is the air outlet end 312, and the plurality of air baffles 31 are arranged at intervals in this embodiment, so the plurality of corresponding air outlet ends 312 arranged at intervals are formed. Therefore, when the soft support 21 is pressed towards the air outlet end 312, the soft support 21 stops at the plurality of air outlet ends 312, and the plurality of air outlet ends 312 collectively support the soft support 21, that is, the multi-point support is achieved, the supporting effect of the soft support 21 is enhanced, and the stability of the soft support 21 is ensured. In addition, the air baffle 31 has a certain width, and the width of the air baffle 31 is equivalent to the width of the air outlet 121. Therefore, the air outlet end 312 of the air baffle 31 has an end surface that is equal in width to the air outlet 121. Therefore, when the soft support 21 stops at the plurality of air outlet ends 312, the soft support 21 forms a multi-stage support with the plurality of air outlet ends 312, thus further enhancing the support stability of the whole soft support 21.

Referring to FIG. 1 and FIG. 2, in this embodiment, in order to achieve uniform air outlet, the plurality of air baffles 31 are arranged at intervals along a longitudinal direction, and air outlet ducts 311 are formed between the adjacent two air baffles 31. The soft support 21 is provided with a plurality of air outlet holes 211 arranged at intervals in a longitudinal and lateral direction. Each air outlet hole 211 in a longitudinal direction respectively corresponds to an outlet of each air outlet duct 311. The plurality of air outlet holes 211 in a lateral direction all correspond to the outlets of the same air outlet ducts 311. Specifically, the air outlet 121 is arranged at intervals in a longitudinal direction on the soft support 21. For example, the air outlet 121 consists of M rows and N columns, where M and N are integers greater than or equal to 1, each row and column is provided with a plurality of air outlet holes 211, and M and N are specifically provided according to the size of the air outlet hole 211 and the area of the soft support 21. The air baffle 31 is arranged at intervals along a longitudinal direction of the skeleton 32, and each column air outlet hole 211 is also arranged along the longitudinal direction of the skeleton 32. It is important that each air outlet duct 311 between adjacent two air baffles 31 corresponds to the air outlet hole 211, so that the airflow will flow along the air outlet duct 311 and be discharged from the air outlet hole 211 corresponding to the air outlet duct 311, each air outlet hole 211 corresponds to each air outlet duct 311, and the airflow will not be discharged from other air outlet holes 211, thus avoiding the generation of turbulence and enhancing the air outlet effect, and each air outlet hole 211 in each column corresponds to each air outlet duct 311 one by one, resulting in uniform air outlet on the soft support 21 and good air outlet effect. In addition, it has been explained before that the air outlet end 312 of the air baffle 31 is an end surface that is equal in width to the air outlet 121, so the outlet of the air outlet duct 311 actually has a certain width. Therefore, the plurality of air outlets 121 arranged at intervals in a longitudinal direction correspond to the outlets of the same air outlet ducts 311. After passing through the air outlet duct 311, the airflow can be discharged together with a plurality of air outlet holes 211 corresponding to the air outlet ducts 311, so as to increase the exhaust air rate, enhance the air outlet effect and it has uniform air outlet. Therefore, by providing air outlet holes 211 arranged in a longitudinal and lateral direction on the soft support 21, the air outlet holes 211 are provided correspondingly to the air outlet ducts 311, thus achieving the uniform distribution of air force.

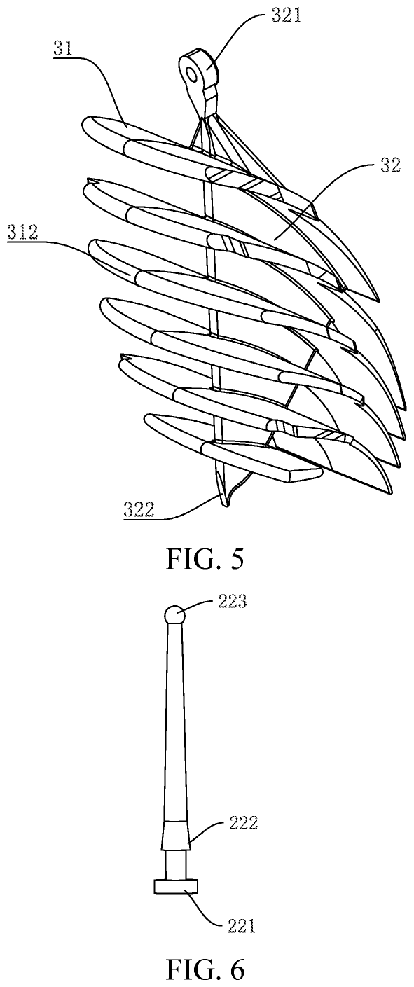

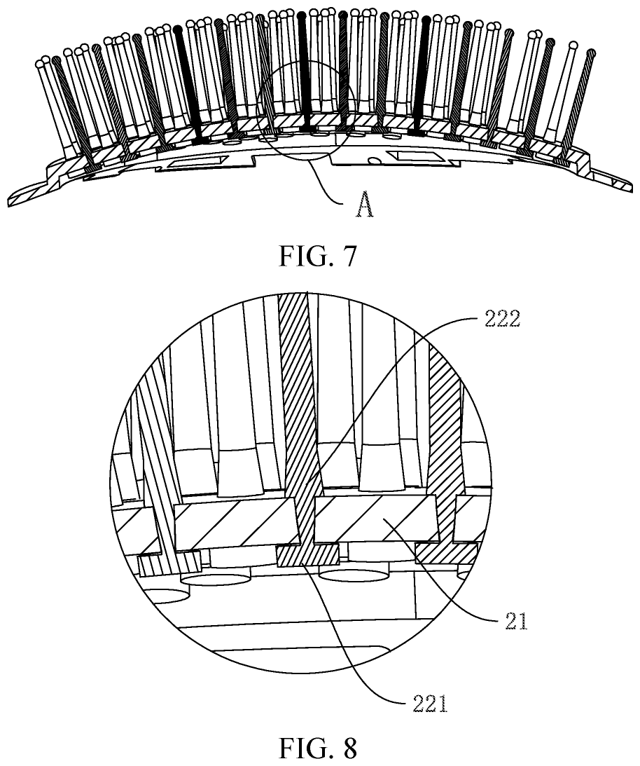

Referring to FIG. 6, FIG. 7 and FIG. 8, in an embodiment, the comb teeth part 20 further includes comb teeth 22. The soft support 21 includes an inner side towards the inside of the comb housing 10 and an outer side facing away from the inner side. The soft support 21 is provided with via holes that run through the inner side and outer side. The comb teeth 22 pass through the via holes. The comb teeth 22 are provided with a first end part 221 connected to the inner side and a second end part 222 connected to the outer side. Specifically, the first end part 221 is a short cylinder. The second end part 222 is a conical cylinder. The first end part 221 and the second end part 222 are adjacently provided to the root of the comb teeth 22. The diameter of the connecting section connected to the first end part 221 and the second end part 222 is smaller than the diameter of the first end part 221 and the second end part 222. A structure with thin middle and thick two ends is formed. The thin middle part passes through the via hole. The thick parts at both ends are respectively connected to the inner side and the outer side of the soft support 21, so that the comb teeth 22 can be firmly fixed on the soft support 21 and the soft support 21 can be prevented from falling off. In addition, the top of the comb teeth 22 is further provided with a spherical bead 223. The spherical bead 223 is placed on the top of the comb teeth 22 through the bead process after the comb teeth 22 passes through the via hole. Due to the curved surface of the bead 223, when the bead 223 contacts the scalp, the contact area with the scalp is small, it will exert no excessive pressure on the scalp, reduce the picotement, and has moderate massage strength and good massage effect.

There are various ways for the soft support 21 to be arranged at the air outlet 121. The soft support 21 can be directly arranged at the air outlet 121 or can be arranged at the air outlet 121 through a connecting part. This embodiment adopts a ring mounting part, and the soft support 21 is arranged at the air outlet 121 through a ring mounting part.

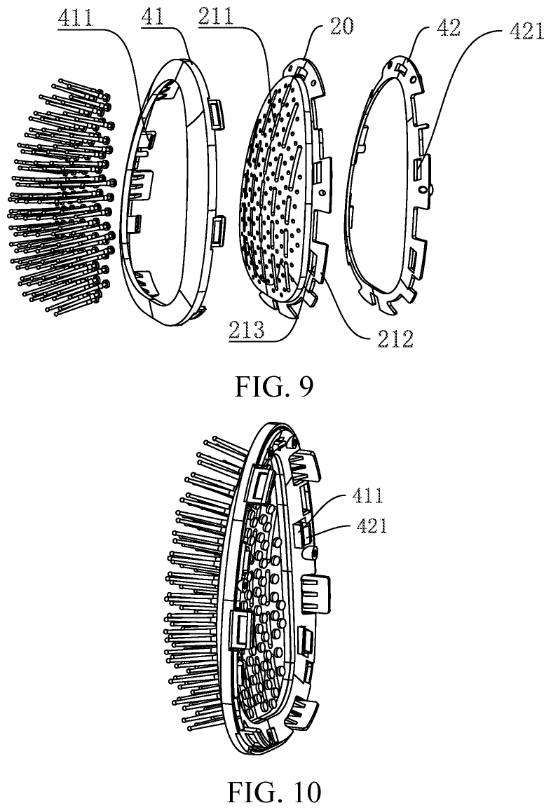

Referring to FIG. 9 and FIG. 10, in an embodiment, the massage comb head further includes a ring mounting part. The outside of the ring mounting part is arranged around the air outlet 121. The inside of the ring mounting part surrounds the soft support 21. The outer side of the ring mounting part surrounds the air outlet 121, and the inside of the ring mounting part surrounds the soft support 21. The ring mounting part is fixed with the air outlet 121, and the soft support 21 is installed on the ring mounting part, so that the soft support 21 is arranged at the air outlet 121. The soft support 21 is located in the inner ring of the ring mounting part, and the ring mounting part will not affect the air outlet, so that the airflow can be smoothly discharged through the air outlet hole 211 on the soft support 21, so as to ensure that the soft support 21 is installed stably and avoid the effect of the air outlet.

In this embodiment, the ring mounting part includes an outer ring connecting part 41 and an inner ring connecting part 42. The outer ring connecting part 41 and the inner ring connecting part 42 are installed in an involution manner. The outer ring connecting part 41 and/or the inner ring connecting part 42 are fixed to the comb housing 10. The edge of the soft support 21 protrudes outward and is provided with a connecting portion 212. The connecting portion 212 is clamped between the outer ring connecting part 41 and the inner ring connecting part 42.

Furthermore, the connecting portion 212 is provided with a through hole 213. One side of the outer ring connecting part 41 towards the inside of the comb housing 10 is provided with a clip 411. The inner ring connecting part 42 is provided with a slot 421. The clip 411 is connected to the slot 421 through the through hole 213 in a buckling manner.

Referring to FIG. 9 and FIG. 10, specifically, the outer ring connecting part 41 and the inner ring connecting part 42 are both in a ring shape. The shape and size of the outer ring connecting part 41 and the inner ring connecting part 42 are matched. The outer ring connecting part 41 is located on the outer side of the comb housing 10, while the inner ring connecting part 42 is located on the inside of the comb housing 10. The outer ring connecting part 41 and the inner ring connecting part 42 are relatively fixed together. The outer ring connecting part 41 is provided with a plurality of clips 411. The inner ring connecting part 42 is provided with a plurality of slots 421. The clips 411 are buckled with the slots 421 to fix the outer ring connecting part 41 and the inner ring connecting part 42 together. The edges of the soft support 21 protrude outward to form a plurality of connecting portions 212. The connecting portions 212 are specifically short edges that protrude laterally. The positions of the short edges correspond to the positions of the clips 411 and the slots 421. There is a through hole 213 on the short edge. The clip 411 first passes through the through hole 213 and then is buckled with the slot 421, thus achieving the mounting of the soft support 21. The connecting portion 212 of the soft support 21 is clamped between the outer ring connecting part 41 and the inner ring connecting part 42. The soft support 21 is located on the inner side of the outer ring connecting part 41 and the inner ring connecting part 42. By using the outer ring connecting part 41 and the inner ring connecting part 42 to clamp the connecting portion 212 of the soft support 21, the soft support 21 can be firmly fixed at the air outlet 121. In addition, it should be noted that both the outer ring connecting part 41 and the inner ring connecting part 42 can be fixed with the comb housing 10, or one of them can be fixed with the comb housing 10. In this embodiment, the outer ring connecting part 41 is fixed with the comb housing 10, and there are corresponding connecting structures on the outer ring connecting part 41 and the inner side wall of the comb housing 10. The outer ring connecting part 41 is fixed to the comb housing 10 through this connecting structure, and there are various types of connecting structures, which are not limited here. When the outer ring connecting part 41 of this embodiment is fixed to the comb housing 10, the outer ring connecting part 41 is also connected to the groove block 123, pressing on the lap joint 322, thus stabilizing the skeleton 32.

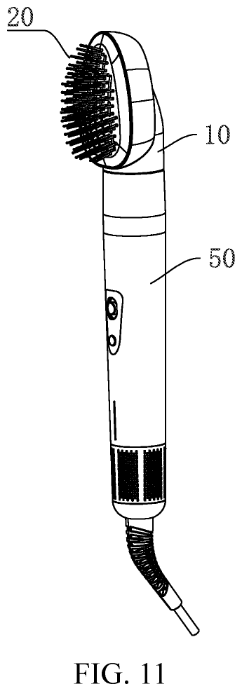

Referring to FIG. 11, an embodiment of the present application provides an electrical massage comb, including a host 50 for providing airflow and the massage comb head as described above, and the massage comb head is installed on the host 50. The top of the host 50 is connected to the air inlet 111 of the comb housing 10, a fan is provided in the host 50 to provide airflow by the fan, and a button is provided on the host 50 to control the operation of the fan. The host 50 has a slender column shape as a whole, which is convenient for users to grasp and achieve styling and massage functions.

Through the implementation of this embodiment, the soft support 21 has strong deformability. When the user massages the scalp with an electrical massage comb, the pressure is exerted to the comb teeth part 20, and the soft support 21 will be deformed and pressed to the air outlet end 312 of the air guide part 30, and the air outlet end 312 will support the soft support 21. The pressure exerted to the comb teeth part 20 is released, and the soft support 21 will rebound to recover its deformation, so that the pressure of the comb teeth 22 on the head will be buffered, and the scalp will not be excessively stimulated, so as to ensure the appropriate massage intensity and enhance the massage effect of the electrical massage comb.

The above is only the specific implementation of the present application, but the scope of the protection of the present application is not limited thereto. Any technical personnel familiar with this technical field can easily think of various equivalent modifications or replacements within the technical scope disclosed by the present application, and these modifications or replacements shall fall within the scope of the protection of the present application. Therefore, the scope of the protection of the present application shall be included in the scope of the protection of the claims.

What is claimed is:

1. A massage comb head, comprising:
a comb housing provided with an air outlet;
an air guide part installed in the comb housing, the air guide part being provided with an air outlet end provided towards the air outlet;
a comb teeth part, comprising a soft support, the soft support being arranged at the air outlet,
wherein the soft support is configured to deform towards the air outlet end and stop at the air outlet end or recover its deformation in a direction far away from the air outlet end.

2. The massage comb head according to claim 1, wherein the soft support bulges in a direction far away from the air outlet end, and a gap is formed between the soft support and the air outlet end for forming the deformation of the soft support.

3. The massage comb head according to claim 2, wherein the soft support is silica gel, and the softness of the silica gel is 30-80 degrees.

4. The massage comb head according to claim 1, wherein the air guide part comprises a plurality of air baffles arranged at intervals, the end surface of the air baffle towards the air outlet is the air outlet end, and a plurality of the air outlet ends collectively stop the soft support.

5. The massage comb head according to claim 4, wherein the plurality of air baffles are arranged at intervals along a longitudinal direction, and air outlet ducts are formed between the adjacent two air baffles; and the soft support is provided with a plurality of air outlet holes arranged at intervals in a longitudinal and lateral direction, wherein each air outlet hole in the longitudinal direction respectively corresponds to an outlet of each air outlet duct; and the plurality of air outlet holes in the lateral direction all correspond to the outlets of the same air outlet ducts.

6. The massage comb head according to claim 1, wherein the comb teeth part further comprises comb teeth, the soft support comprises an inner side towards the inside of the comb housing and an outer side facing away from the inner side, and the soft support is provided with via holes that run through the inner side and outer side, wherein the comb teeth pass through the via holes, and the comb teeth are provided with a first end part connected to the inner side and a second end part connected to the outer side.

7. The massage comb head according to claim 1, wherein the massage comb head further comprises a ring mounting part, the outside of the ring mounting part is arranged around the air outlet, and the inside of the ring mounting part surrounds the soft support.

8. The massage comb head according to claim 7, wherein the ring mounting part comprises an outer ring connecting part and an inner ring connecting part, the outer ring connecting part and the inner ring connecting part are installed in an involution manner, and the outer ring connecting part and/or the inner ring connecting part are fixed to the comb housing; and the edge of the soft support protrudes outward and is provided with a connecting portion, and the connecting portion is clamped between the outer ring connecting part and the inner ring connecting part.

9. The massage comb head according to claim 8, wherein the connecting portion is provided with a through hole, one side of the outer ring connecting part towards the inside of the comb housing is provided with a clip, the inner ring connecting part is provided with a slot, and the clip is connected to the slot through the through hole in a buckling manner.

10. An electrical massage comb, comprising a host for providing airflow and the massage comb head according to claim 1, and the massage comb head is installed on the host.

11. The electrical massage comb according to claim 10, wherein the soft support bulges in a direction far away from the air outlet end, and a gap is formed between the soft support and the air outlet end for forming the deformation of the soft support.

12. The electrical massage comb according to claim 11, wherein the soft support is silica gel, and the softness of the silica gel is 30-80 degrees.

13. The electrical massage comb according to claim 10, wherein the air guide part comprises a plurality of air baffles arranged at intervals, the end surface of the air baffle towards the air outlet is the air outlet end, and a plurality of the air outlet ends collectively stop the soft support.

14. The electrical massage comb according to claim 13, wherein the plurality of air baffles are arranged at intervals along a longitudinal direction, and air outlet ducts are formed between the adjacent two air baffles; and the soft support is provided with a plurality of air outlet holes arranged at intervals in a longitudinal and lateral direction, wherein each air outlet hole in the longitudinal direction respectively corresponds to an outlet of each air outlet duct; and the plurality of air outlet holes in the lateral direction all correspond to the outlets of the same air outlet ducts.

15. The electrical massage comb according to claim 10, wherein the comb teeth part further comprises comb teeth, the soft support comprises an inner side towards the inside of the comb housing and an outer side facing away from the inner side, and the soft support is provided with via holes that run through the inner side and outer side, wherein the comb teeth pass through the via holes, and the comb teeth are provided with a first end part connected to the inner side and a second end part connected to the outer side.

16. The electrical massage comb according to claim 10, wherein the massage comb head further comprises a ring mounting part, the outside of the ring mounting part is arranged around the air outlet, and the inside of the ring mounting part surrounds the soft support.

17. The electrical massage comb according to claim 16, wherein the ring mounting part comprises an outer ring connecting part and an inner ring connecting part, the outer ring connecting part and the inner ring connecting part are installed in an involution manner, and the outer ring connecting part and/or the inner ring connecting part are fixed to the comb housing; and the edge of the soft support protrudes outward and is provided with a connecting portion, and the connecting portion is clamped between the outer ring connecting part and the inner ring connecting part.

18. The electrical massage comb according to claim 17, wherein the connecting portion is provided with a through hole, one side of the outer ring connecting part towards the inside of the comb housing is provided with a clip, the inner ring connecting part is provided with a slot, and the clip is connected to the slot through the through hole in a buckling manner.
